(19) United States
(12) Patent Application Publication
(10) Pub. No.: US 2020/0157819 A1
(43) Pub. Date: May 21, 2020

(54) NON-SLIP REINFORCING BAR COUPLER

(71) Applicant: N C COUPLER LLC, Irvine, CA (US)

(72) Inventors: Hyun Uk Lee, Busan (KR); Jae Don Lim, Yongin (KR)

(73) Assignee: N C COUPLER LLC, Irvine, CA (US)

(21) Appl. No.: 16/658,025

(22) Filed: Oct. 19, 2019

(30) Foreign Application Priority Data
Nov. 19, 2018 (KR) 10-2018-0142474
Dec. 27, 2018 (KR) 10-2018-0170818

(51) Int. Cl. E04C 5/16; F16B 7/18

(52) U.S. Cl. CPC E04C 5/165; F16B 7/182

(57) ABSTRACT

A non-slip reinforcing bar coupler includes a coupler body, a stopper, and a thread formed on outer surfaces thereof, a cap having an insertion hole, a cap body having a thread for screw-coupling with the coupler body, and an inclined surface formed on an inner surface of the insertion hole thereof, a locker having pressing pieces that have a cross section of an arc shape, a spike protruding from an inner surface of the pressing piece, and an outer inclined surface formed on a front outer surface of the pressing piece at the same inclination as the inclined surface of the cap, the rear side of the locker being inserted into the cap, and a support member located between the coupler body and the locker, deformed when the cap is tightened, and allowing the locker to be displaced to the coupler body by a certain displacement.

### CROSS-REFERENCE TO RELATED APPLICATIONS

This U.S. non-provisional patent application claims priority under 35 U.S.C. § 119 of Korean Patent Application No. 10-2018-0142474 filed on Nov. 19, 2018 and Korean Patent Application No. 10-2018-0170818 filed on Dec. 27, 2018, the entire contents of which are hereby incorporated by reference.

### BACKGROUND OF THE INVENTION

The present invention disclosed herein relates to a reinforcing bar coupler, and more particularly, to a reinforcing bar coupler which maintains firm coupling without a slip of the reinforcing bar even if a tensile force is applied, allows a work to be easy, and has excellent adhesion to concrete when buried in concrete.

In general, concrete is a mixture of cement, sand, gravel, water, etc., and has a relatively high compressive strength, but has a very low tensile strength compared to the compressive strength, resulting in easy occurrence of crack.

In order to reinforce the strength of such concrete, reinforcing bars are placed in forms where concrete is cast and concrete is cured, thereby reinforcing the strength of concrete.

Since this typical reinforced concrete structure has excellent compressive and tensile strengths, the reinforced concrete structure is being applied to construct various types of structures. Also, since the reinforced concrete structure excellent physical properties, it is being widely used as a structure of various constructions and civil engineering structures.

Reinforcing bars used in concrete reinforcement are divided into plain bar and deformed bar. The plain bar has no protrusion on the surface of the bar, and the deformed bar has lugs and ribs.

The deformed bar has greater adhesive strength with concrete than the plain bar, and when the crack occurs in concrete, the width of crack is smaller than that of the plain bar. Accordingly, the deformed bars are being commonly used as main reinforcing bars instead of the plain bars.

The reinforcing bar placement work is performed at the time of building various concrete structures of architecture and civil engineering. In this case, since reinforcing bars are manufactured in a standardized length, it is necessary to connect reinforcing bars having a certain length to each other.

In a typical reinforcing bar placement work, methods for connecting reinforcing bars include a lap joint method, a welding joint method, a screw joint method, and a coupler joint method. The lap joint method has an advantage in that the reinforcing bar placement work is relatively easy by winding wires on the ends of the reinforcing bars overlapping each other. However, since wires need to be wound for each deformed bar, the work is inconvenient and the bending strength of the connection portion is weak, resulting in a safety risk.

On the other hand, the welding joint method is a method of welding the ends of reinforcing bars against each other, and the strength of the connection portion is good, but the work is very cumbersome and takes a long time, resulting in delay of construction.

The screw joint method is a method of interconnecting reinforcing bars by processing a screw on the connection end portions of the deformed reinforcing bar, and requires separate equipment for processing the connection end portions.

In order to overcome these limitations, Korean Patent No. 1030579 discloses a ‘reinforcing bar coupler’. In this disclosure, the reinforcing bar coupler is formed to has a symmetrical shape about a center of a longitudinal direction such that a pair of reinforcing bars are inserted into each of the outer ends of both sides of a hollow cylindrical tube, and includes a threaded coupler cap and a tightening spring to which the thread are coupled.

Such reinforcing bar coupler has a limitation in that each part making contact with the tightening spring is subjected to intensive stress and thus is sheared at a gripping portion.

In addition, Korean Patent No. 1003302 discloses a ‘high strength reinforcing bar coupler’, and Korean Patent No. 0977658 discloses an ‘apparatus for connecting bars’, which have a limitation in that a slip occurs when a tensile force is applied to reinforcing bars.

### SUMMARY OF THE INVENTION

The present invention provides a reinforcing bar coupler which can maintain firm coupling without a slip of the reinforcing bar even if a large tensile force is applied.

The present invention also provides a reinforcing bar coupler which enables very simple and quick construction.

Embodiments of the present invention provide non-slip reinforcing bar couplers including: a coupler body having an insertion hole formed at both sides thereof, a stopper formed at a center of the inside thereof, and a thread formed on outer surfaces of both sides thereof; a cap having an insertion hole formed at one side thereof, a cap body having a thread for screw-coupling with the thread of the coupler body formed on an inner surface of the other side thereof, and an inclined surface formed on an inner surface of the insertion hole thereof; a locker having a certain number of pressing pieces having a cross section of an arc shape, a spike protruding from an inner surface of the pressing piece, and an outer inclined surface formed on a front outer surface of the pressing piece at the same inclination as the inclined surface of the cap, the rear side of the locker being inserted into the cap while making contact with the body; and a support member located between the coupler body and the locker, deformed when the cap is tightened, and allowing the locker to be displaced to the coupler body by a certain displacement, wherein: the support member is a separate part fastened between the body and the locker; the support member includes a contact plate having an insertion hole formed at the center thereof, and a buckling flange protruding to one side of the contact plate, the contact plate and the buckling flange being integrally formed to have a cylindrical shape with one side thereof open and the contact plate and the buckling flange having an orthogonal L-shaped cross section; the support member converts a tightening force of the cap into a compressive force of the locker against a reinforcing bar through the buckling flange as the cap is tightened, and simultaneously, maintains the tightening force of the cap through a surface contact of the contact plate with the coupler body or the locker; and as the cap is continuously tightened, deformation such as buckling or crushing occurs on the buckling flange of the support member by a force of pressing the support member by the locker, and the locker moves in a direction of the body in response to the deformation to increase the compressive force against the reinforcing bar and the tightening force of the cap.

In some embodiments, the locker may further include: a coupling ring inserted into a groove of an outer surface of the pressing piece to gather the pressing pieces and maintain a pipe shape; and an open ring having a ring shape and inserted into the pressing pieces to spread the front side of each pressing piece.

In other embodiments, the open ring may be inserted into the pressing piece at the front and rear sides of the coupling ring.

In still other embodiments, the coupler body may have check holes perforated to the inside of the insertion hole in the opposite directions to each other at both sides of the stopper of the coupler body.

In even other embodiments, the locker may have an inner inclined surface formed on a front inner surface thereof.

In yet other embodiments, the open ring of the locker may be formed of an elastic material and may be formed in a partially broken ring shape.

In further embodiments, the cap may include a tool fastening portion formed on an outer surface thereof to rotate the cap by a tool.

In still further embodiments, the non-slip reinforcing bar coupler may include a spring inserted into an open one side of the support member and elastically supporting the locker.

### BRIEF DESCRIPTION OF THE DRAWINGS

The accompanying drawings are included to provide a further understanding of the present invention, and are incorporated in and constitute a part of this specification. The drawings illustrate exemplary embodiments of the present invention and, together with the description, serve to explain principles of the present invention. In the drawings:

FIG. 1 is a perspective view illustrating a reinforcing bar coupler according to an embodiment of the present invention;

FIG. 2 is an exploded perspective view illustrating a reinforcing bar coupler according to an embodiment of the present invention;

FIG. 3 is a cross-sectional view illustrating a body structure constituting according to an embodiment of the present invention;

FIG. 4 is a perspective view illustrating a support member structure according to an embodiment of the present invention;

FIG. 5 is a perspective view illustrating a locker structure according to an embodiment of the present invention;

FIG. 6 is a cross-sectional view illustrating a cap structure according to an embodiment of the present invention;

FIGS. 7 to 11 are views sequentially illustrating a process of connecting reinforcing bars according to an embodiment of the present invention; and

FIG. 12 is a cross-sectional view illustrating a reinforcing bar coupler according to another embodiment of the present invention.

### DETAILED DESCRIPTION OF PREFERRED EMBODIMENTS

Preferred embodiments of the present invention will be described below in more detail with reference to the accompanying drawings. The present invention may, however, be embodied in different forms and should not be constructed as limited to the embodiments set forth herein. Rather, these embodiments are provided so that this disclosure will be thorough and complete, and will fully convey the scope of the present invention to those skilled in the art.

Hereinafter, it will be described about an exemplary embodiment of the present invention in conjunction with the accompanying drawings.

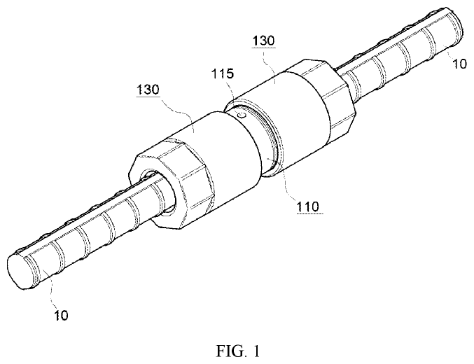

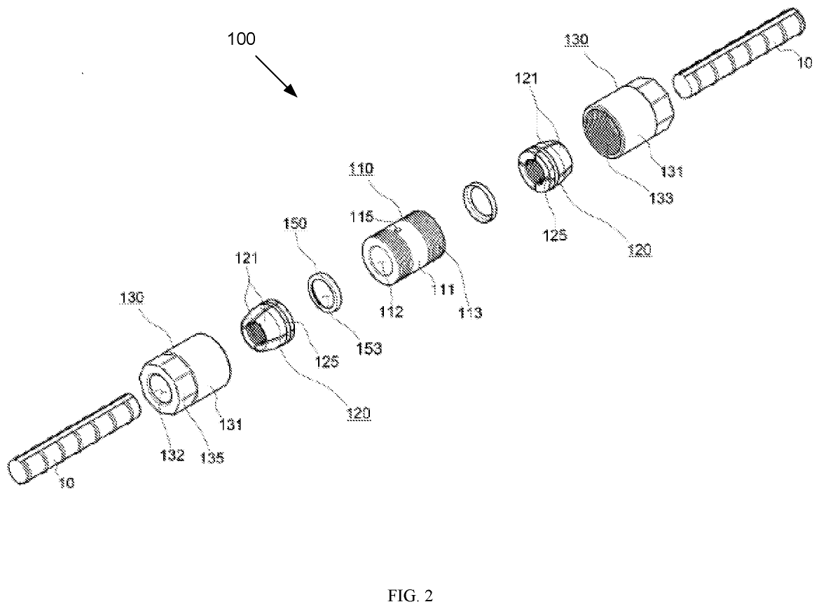

As shown in FIGS. 1 and 2, a non-slip reinforcing bar coupler according to an embodiment of the present invention includes a body 110, a locker 120 making contact with both sides of the body 110, a support member 150 is inserted between the body 110 and the locker 120, and a cap 130 screwed to the body 110 while the locker 120 is inserted into the cap 130.

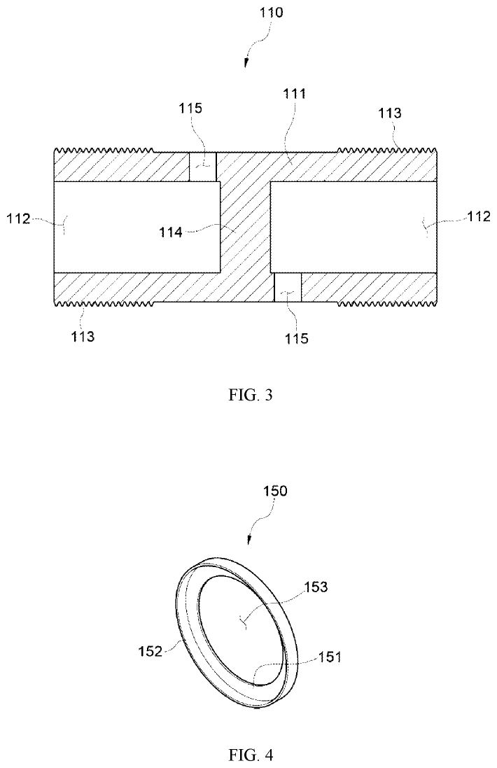

As shown in FIGS. 2 and 3, the body 110 includes a body 111 having a shape of a circular pipe, and both sides of the body 111 are formed with insertion holes 112 into which reinforcing bars are inserted, respectively. Also, a stopper 114 is formed in the middle of the inside of the body 111.

Also, a thread 113 is formed on an outer surface of the body 111, and check holes 115 are formed at both sides of the stopper 114 and are perforated to the inside of the body 111.

If the check holes 115 are formed in the same direction, the rigidity of the body 110 may be weakened. Accordingly, the check holes 115 at both sides of the stopper 114 may be in different directions, preferably, in opposite directions as shown in FIG. 3.

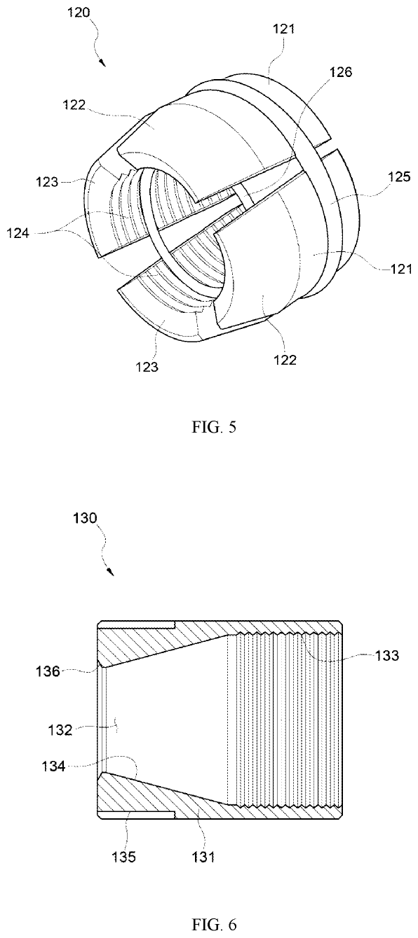

As shown in FIGS. 2 and 4, the support member 150 includes a contact plate 151 with an insertion hole 153 having a perforated hole shape formed at the center thereof, and a buckling flange 152 protruding toward one side of the contact plate 151. The contact plate 151 and the buckling flange 152 are integrally formed to have a cylindrical shape with one side thereof open, and the contact plate 151 and the buckling flange 152 have an orthogonal L-shaped cross section.

As shown in FIG. 2, the support member 150 configured as described above is inserted so as to be located between the body 110 and the locker 120. The support member 150 located between the body 110 and the locker 120 converts a tightening force of the cap 130 into a compressive force of the locker 120 against a reinforcing bar through the buckling flange 152 as the cap 130 is tightened, and simultaneously, maintains the tightening force of the cap 130 through a surface contact of the contact plate 151 with the body 110 or the locker 120. Also, as the cap 130 is continuously tightened, deformation such as buckling or crushing may occur on the buckling flange 152 of the support member 150 by a force of pressing the support member 150 by the locker 120, and the locker 120 moves in a direction of the body 110 in response to this deformation, thereby further improving the compressive force against the reinforcing bar and the tightening force of the cap 130.

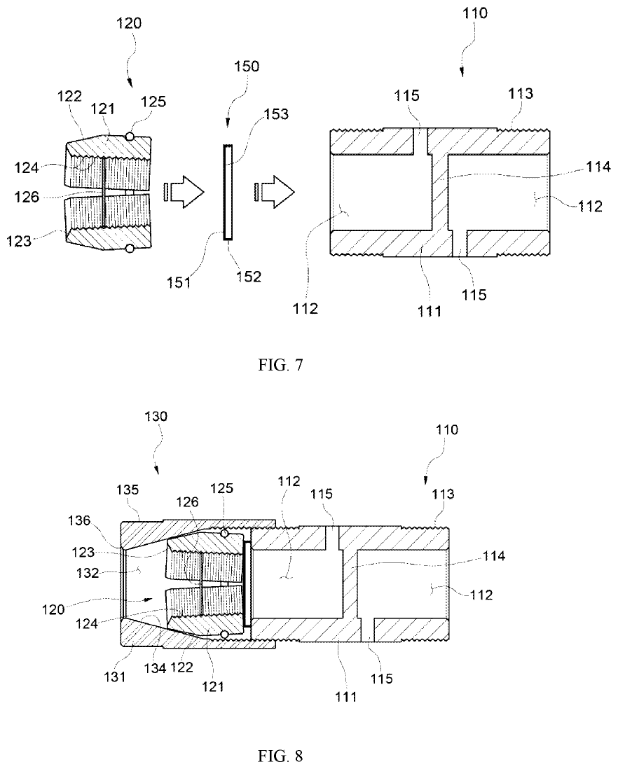

As shown in FIGS. 2 and 5, the locker 120 includes a certain number of pressing pieces 121 having a cross section of an arc shape as if a pipe is divided into certain number in an axial direction. Also, a groove is formed on an outer surface of each of the pressing pieces 121, and a coupling ring 125 formed of a rubber material is inserted into the groove, thereby gathering the pressing pieces 121 divided into a certain number to form the pipe-shaped locker 120 as shown in FIG. 5.

An outer inclined surface 122 is formed on the front outer surface of the pressing piece 121, and an inner inclined surface 123 is formed on the front inner surface of the pressing piece 121. The inner inclined surface 123 has a larger inclination angle than that of the outer inclined surface 122.

Spikes 124 having a protrusion shape are formed on the inner surface of each pressing piece 121 constituting the locker 120, and an open ring 126 having a ring shape, partially broken and having elasticity is inserted into the locker 120.

The diameter of the open ring 126 is formed larger than the inner diameter of the pipe-shaped locker 120 formed by gathering the pressing pieces 121.

As described above, the coupling ring 125 is coupled to the groove formed on the outer surface of the certain number of pressing pieces 121 such that the pressing pieces 121 form the locker 120 in the form of a pipe and the open ring 126 of a ring shape is inserted into the locker 120. Thus, the rear of the locker 120 is gathered by the coupling ring 125, and the front of the locker 120 is spread by the open ring 126. Accordingly, as shown in FIG. 5, the initial shape is configured such that the front side of the pressing pieces 121 constituting the locker 120 is spread.

In FIG. 5, the open ring 126 is inserted in a direction of the inner inclined surface 123 based on the coupling ring 125, but it is more preferable to insert the open ring 126 at both sides of the coupling ring 125.

The open ring 126 in the direction of the inner inclined surface 123, which is one side of the coupling ring 125, spreads the pressing piece 121 such that the reinforcing bar 10 can be easily inserted, and the open ring 126 at the other side serves to support from the inside such that the pipe shape formed by the pressing pieces 121 does not collapse by elastic pressure of the coupling ring 125.

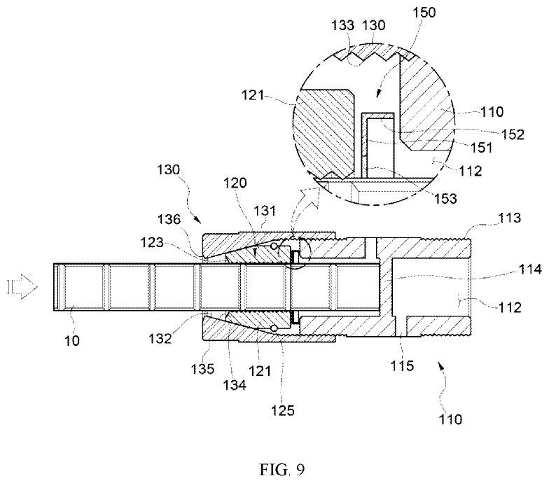

As shown in FIGS. 2 and 6, the cap 130 includes a body 131 having a pipe shape, and a thread 133 for screw coupling with the thread 113 of the body 110 is formed on the inner surface of one side of the body 131. Also, an insertion hole 132 is formed at the other side of the body 131, and an inclined surface 134 is formed on the inner surface of the insertion hole 132.

Preferably, an inclined surface may also be formed on the inner surface of the insertion hole 132 such that the reinforcing bar can be easily inserted.

Also, a tool fastening portion 135 may be formed on the outer surface of the cap 130 such that the cap 130 can be rotated by fastening a tool to the tool fastening portion 135. The tool fastening portion 135 may be configured in various forms, but in this embodiment of the present invention, may be formed by chamfering the outer surface of the body 131 such that the cap 130 can be rotated by a tool such as a wrench.

As shown in FIG. 2, the locker 120 makes contact with both sides of the body 110, and the reinforcing bar 10 is fastened while the cap 130 is screwed with the body 110.

Hereinafter, a process of fastening the reinforcing bar 10 using the reinforcing bar coupler 100 according to an embodiment of the present invention will be described.

First, in order to fasten the reinforcing bar 10, the body 110, the locker 120 and the cap 130 are coupled in a temporary assembly form, and thus the coupler 100 is prepared.

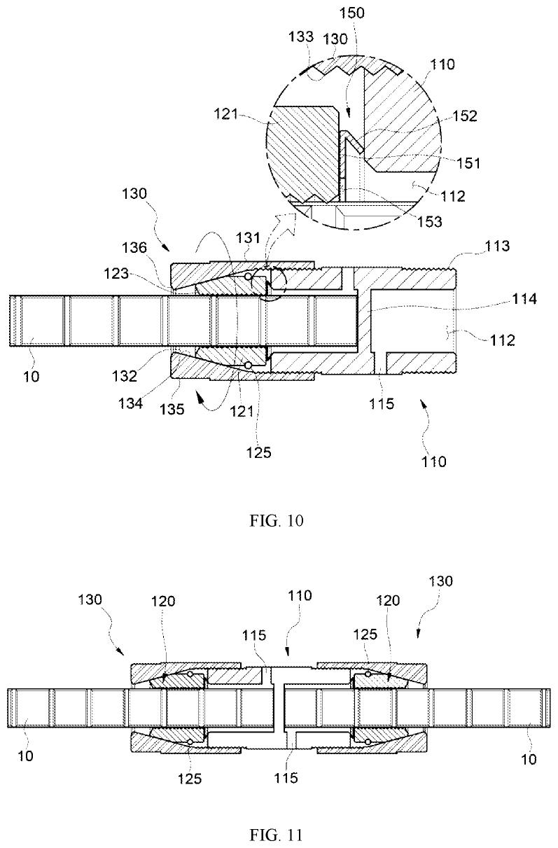

When the support member 150 is located between the body 110 and the locker 120 as shown in FIG. 7, the cap 130 is slightly screwed to the body 110 to be in a temporarily coupled state as shown in FIG. 8.

Also, when the support member 150 is located between the body 110 and the locker 120, the cap 130 is slightly screwed to the opposite side of the body 110, allowing the coupler 100 to be in a temporarily coupled state.

In this embodiment of the present invention, although the support member 150 is installed such that the contact plate 151 of the support member 150 makes contact with the locker 120 and the buckling flange 152 of the support member 150 makes contact with the body 110, the support member 150 may be installed such that the contact plate 151 makes contact with the body 110 and the buckling flange 152 makes contact with the locker 120.

In this case, the front side of the pressing piece 121 of the locker 120 is opened as shown in FIG. 8.

In this state, when the reinforcing bar 20 is inserted into the insertion hole 132 of the cap 130 as shown in FIG. 9, the reinforcing bar 20 penetrates into the locker 120 inside the cap 130 to be inserted into the insertion hole 153 of the support member 150 and the insertion hole 112 of the body 110 and stopped while being caught by the stopper 114 of the body 110.

In this case, a worker can visually check whether or not the reinforcing bar 10 is inserted to the end through the check hole 115 of the body 110.

When the reinforcing bar 10 is inserted into the coupler 100 as described above, the reinforcing bar 10 is smoothly inserted along the central axis of the coupler 100 through the inclined surface 136 formed on the outside of the insertion hole 132 of the cap 130 and the inner inclined surface 123 of the locker 120.

After a worker confirms through the check hole 115 that the reinforcing bar 10 is inserted to the end, the cap 130 is tightened in a direction of the body 110 by rotating the cap 130 as shown in FIG. 10.

When the cap 130 is tightened by fastening a tool such as a wrench to the tool fastening portion 135 formed on the outer surface of the cap 130, the cap 130 screw-coupled with the body 110 moves to the body 110.

As shown in FIG. 9, the inclined surface 134 is formed on the inner surface of the cap 130 and the outer inclined surface 122 is formed on the outer surface of the locker 120 inserted into the cap 130. Accordingly, when the cap 130 moves in the direction of body 110, the opened front portion of the cap 130 is closed and each pressing piece 121 of the locker 120 makes contact with the outer surface of the reinforcing bar 10 while the outer inclined surface 122 of the locker 120 makes contact with the inclined surface 134 of the cap 130.

In this case, since the open ring 126 inside the locker 120 has a partially broken ring shape, the open ring 126 is elastically deformed while end portions thereof deviate from each other.

When a worker continuously tightens the cap 130 with a tool, the spikes 124 protruding on the inner surfaces of the respective pressing pieces 121 of the locker 120 dig into the outer surface (lug and rib) of the reinforcing bar 10 while the outer inclined surface 122 of the locker 120 moves along the inclined surface 134 of the cap 130. Thus, the reinforcing bar 10 is fastened and fixed to the coupler 100 as shown in FIG. 10.

Since the support member 150 is located between the body 110 and the locker 120 as shown in FIG. 8, when the cap 130 is tightened as described above, a force of pressing the support member 150 by the locker 120 also acts together with a force of pressing the outer surface of the reinforcing bar 10 by the pressing piece of the locker 120.

By the force of pressing the support member 150 by the locker 120 when the cap 130 is tightened, the buckling flange 152 of the support member 150 is deformed (e.g., buckling or crushing) as shown in FIGS. 9 and 10, and the locker 120 moves in the direction of the body 110 by the amount of deformation of the support member 150.

In the process of fastening the reinforcing bar 10 to the coupler 100 as described above, since the locker 120 presses the reinforcing bar 10 while inclinedly moving in the direction of the body 110 by the amount of deformation of the support member 150, the coupling force becomes better, and no slip occurs after fastening.

Thus, the support member 150 located between the body 110 and the locker 120 converts a tightening force of the cap 130 into a compressive force of the locker 120 against a reinforcing bar through the buckling flange 152 as the cap 130 is tightened, and simultaneously, maintains the tightening force of the cap 130 through a surface contact of the contact plate 151 with the body 110 or the locker 120. Also, as the cap 130 is continuously tightened, deformation such as buckling or crushing may occur on the buckling flange 152 of the support member 150 by a force of pressing the support member 150 by the locker 120, and the locker 120 moves in a direction of the body 110 in response to this deformation, thereby further improving the compressive force against the reinforcing bar and the tightening force of the cap 130.

As shown in FIG. 11, the reinforcing bar 10 is fastened to the opposite direction of the coupler 100 by the above-described manner.

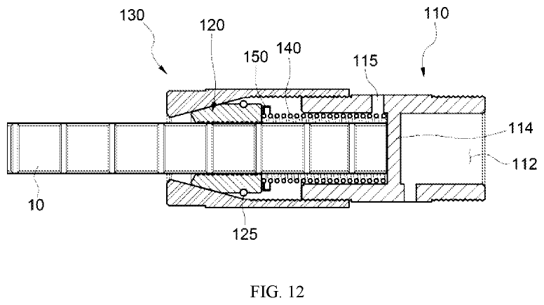

FIG. 12 is a view illustrating a reinforcing bar coupler 100 according to another embodiment of the present invention.

According to another embodiment of the present invention, a spring 140 is further included between the locker 120 and the body 110 of the previous embodiment.

As shown in FIG. 12, when the spring 140 is inserted between the locker 120 and the body 110, the spring 140 elastically presses the locker 120 in the direction of the insertion hole, and the open ring 120 inserted into the locker 126 generates a force that pushes each pressing piece 121 to the outside. Accordingly, the forces by the elasticity of the spring 140 and the elasticity of the open ring 126 are balanced on the outer inclined surface 122 of the locker 120 and the inclined surface 134 of the cap 130, and thus the inner diameter of the locker 120 is maintained in a size slightly smaller than the outer diameter of the reinforcing bar 10.

In this state, when the reinforcing bar 10 is inserted into the insertion hole 132 of the cap 130, the reinforcing bar 10 is inserted into the locker 120 along the inner inclined surface 123 of the front of the locker 120 to be accurately inserted along the axis center of the coupler 100 while spreading the pressing pieces 121.

Also, when the reinforcing bar 10 is inserted into the coupler 100, the reinforcing bar 10 can be accurately inserted into the axis center of the coupler 100 while the feeling and sound that the spikes 124 inside the locker 120 are caught by the lugs of reinforcing bar 10 are generated, thereby enabling smoother work.

Thus, since the reinforcing bar 10 is tightly fastened only by two operations of inserting the reinforcing bar 10 into the coupler 100 and tightening the cap 130, the fastening work can be very simply and quickly performed.

The outer diameter of the cap 130 is formed larger than the outer diameter of the body 110 and thus a groove is formed between the pair of caps 130 as shown in FIGS. 1 and 10. Accordingly, when the coupler 110 is buried in concrete, the bonding strength with concrete is very good and thus the strength of the cured reinforced concrete becomes better.

The non-slip reinforcing bar coupler configured as described above can maintain firm coupling without a slip of the reinforcing bar even if a large tensile force is applied to the reinforcing bar by an earthquake or the like.

Also, since the reinforcing bar is fastened to the coupler only by insertion of the reinforcing bar into the coupler and the cap tightening work, the fastening work can be very simply and quickly performed.

The technical spirit of the present invention has been described through the above-described embodiments.

The above-disclosed subject matter is to be considered illustrative and not restrictive, and the appended claims are intended to cover all such modifications, enhancements, and other embodiments, which fall within the true spirit and scope of the present invention. Thus, to the maximum extent allowed by law, the scope of the present invention is to be determined by the broadest permissible interpretation of the following claims and their equivalents, and shall not be restricted or limited by the foregoing detailed description.

What is claimed is:

1. A non-slip reinforcing bar coupler comprising:
a coupler body having an insertion hole formed at both sides thereof, a stopper formed at a center of the inside thereof, and a thread formed on outer surfaces of both sides thereof;
a cap having an insertion hole formed at one side thereof, a cap body having a thread for screw-coupling with the thread of the coupler body formed on an inner surface of the other side thereof, and an inclined surface formed on an inner surface of the insertion hole thereof;
a locker having a certain number of pressing pieces having a cross section of an arc shape, a spike protruding from an inner surface of the pressing piece, and an outer inclined surface formed on a front outer surface of the pressing piece at the same inclination as the inclined surface of the cap, the rear side of the locker being inserted into the cap while making contact with the body; and
a support member located between the coupler body and the locker, deformed when the cap is tightened, and allowing the locker to be displaced to the coupler body by a certain displacement,
wherein:
the support member is a separate part fastened between the body and the locker;
the support member comprises a contact plate having an insertion hole formed at the center thereof, and a buckling flange protruding to one side of the contact plate, the contact plate and the buckling flange being integrally formed to have a cylindrical shape with one side thereof open and the contact plate and the buckling flange having an orthogonal L-shaped cross section;
the support member converts a tightening force of the cap into a compressive force of the locker against a reinforcing bar through the buckling flange as the cap is tightened, and simultaneously, maintains the tightening force of the cap through a surface contact of the contact plate with the coupler body or the locker; and
as the cap is continuously tightened, deformation such as buckling or crushing occurs on the buckling flange of the support member by a force of pressing the support member by the locker, and the locker moves in a direction of the body in response to the deformation to increase the compressive force against the reinforcing bar and the tightening force of the cap.

2. The non-slip reinforcing bar coupler of claim 1, wherein the locker further comprises:
a coupling ring inserted into a groove of an outer surface of the pressing piece to gather the pressing pieces and maintain a pipe shape; and
an open ring having a ring shape and inserted into the pressing pieces to spread the front side of each pressing piece.

3. The non-slip reinforcing bar coupler of claim 2, wherein the open ring is inserted into the pressing piece at the front and rear sides of the coupling ring.

4. The non-slip reinforcing bar coupler of claim 1, wherein the coupler body has check holes perforated to the inside of the insertion hole in the opposite directions to each other at both sides of the stopper of the coupler body.

5. The non-slip reinforcing bar coupler of claim 1, wherein the locker has an inner inclined surface formed on a front inner surface thereof.

6. The non-slip reinforcing bar coupler of claim 2, wherein the open ring of the locker is formed of an elastic material and is formed in a partially broken ring shape.

7. The non-slip reinforcing bar coupler of claim 1, wherein the cap comprises a tool fastening portion formed on an outer surface thereof to rotate the cap by a tool.

8. The non-slip reinforcing bar coupler of claim 1, comprising a spring inserted into an open one side of the support member and elastically supporting the locker.
